(19) United States
(12) Patent Application Publication
(10) Pub. No.: US 2005/0258231 A1
(43) Pub. Date: Nov. 24, 2005

(54) Cruise ship passenger and baggage processing system

(76) Inventor: Keith Wiater, Ft. Lauderdale, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/130,938

(22) Filed: May 17, 2005

Related U.S. Application Data
(60) Provisional application No. 60/572,003, filed on May 18, 2004.

(51) Int. Cl. G06F 17/00

(52) U.S. Cl. 235/375; 340/572.1; 340/5.1; 705/28

(57) ABSTRACT

A system and method for processing a cruise ship passenger and the passenger's baggage for travel on an airline flight departing from a departure airport includes, on a cruise ship or at a cruise ship terminal, collecting baggage from the cruise ship passenger, marking the collected baggage with an identifier including passenger identifying information and airline identifying information, and issuing a boarding pass to the passenger, the passenger having previously purchased a ticket for the flight.

### CROSS REFERENCE TO RELATED APPLICATION

The present application claims the priority of U.S. provisional patent application Ser. No. 60/572,003 filed May 18, 2004.

### FIELD OF THE INVENTION

The invention relates to systems, methods, and facilities for processing cruise ship passengers and their baggage through an airport or other transportation facility.

### BACKGROUND

Baggage can impose a number of physical constraints and inconveniences on a cruise ship passenger. For example, at the termination of a cruise, a cruise ship passenger with plans to fly to another destination (e.g., a home city) must carry his baggage from the cruise ship terminal until check-in at the airport. Typically, the time between disembarkment and airline check-in spans several hours. During this time, a cruise ship passenger may want to sight-see at the disembarkment location. However, such sight-seeing is often inconvenient because the cruise ship passenger is physically encumbered with baggage. In addition, during the process, a cruise ship passenger is further inconvenienced by the process of checking in for a flight at the departure airport as this process can sometimes take more than 2 to 3 hours.

### SUMMARY

The invention relates to a system and method for processing cruise ship passengers and their baggage that eliminates the need for such passengers to (a) carry baggage from a cruise ship terminal to a departure airport and (b) endure long waits at an airport check-in facility. Thus, the system and method of the invention eliminate much of the inconvenience and delay associated with traveling back home after a cruise.

Accordingly, the invention features a method for processing at least one (e.g., at least 25, 100, or 200) cruise ship passenger's baggage for transport on an airline flight departing from a departure airport. The method includes the steps of: (a) collecting baggage from the at least one cruise ship passenger at a cruise ship terminal; and (b) marking the collected baggage with an identifier (e.g., a barcode, an RFID device, and/or a pseudo baggage card) at the cruise ship terminal, the identifier including passenger identifying information and airline flight identifying information. This method can further include the step of issuing a baggage claim receipt to the passenger.

Also within the invention is a method for processing at least one (e.g., at least 25, 100, or 200) cruise ship passenger for travel on an airline flight. This method includes the step of: issuing a boarding pass for the airline flight to the passenger on a cruise ship or at a cruise ship terminal, wherein the passenger has previously purchased a ticket for the flight. This method can further include subjecting the at least one passenger to security screening (e.g., submitting the at least one passenger's name to the Computer Assisted Passenger Profiling System).

In another aspect, the invention features a method for processing at least one (e.g., at least 25, 100, or 200) cruise ship passenger and the passenger's baggage for travel on an airline flight departing from a departure airport. This method includes the steps of, on a cruise ship or at a cruise ship terminal, (a) collecting baggage from the at least one cruise ship passenger and marking the collected baggage with an identifier including passenger identifying information and airline identifying information; and (b) issuing a boarding pass to the at least one passenger, the at least one passenger having previously purchased a ticket for the flight. The foregoing can be performed at a kiosk located at the cruise ship terminal. In this method, the at least one passenger can have provided the airline operating the flight with information prior to boarding the cruise ship. The passenger can also have been issued the boarding pass while on board the cruise ship.

This method can additionally include the step of transporting the collected baggage to the departure airport (e.g., to a screening facility located at the departure airport but at least 0.1 km away form any passenger terminal).

Although methods and systems similar or equivalent to those described herein can be used in the practice or testing of the present invention, suitable methods and systems are described below. All publications, patent applications, patents, and other references mentioned herein are incorporated by reference in their entirety. In the case of conflict, the present specification, including definitions will control. In addition, the particular embodiments discussed below are illustrative only and not intended to be limiting.

### BRIEF DESCRIPTION OF THE DRAWINGS

FIG. 1 is a diagram illustrating the processing of baggage according to the present invention.

FIG. 2 is a diagram illustrating transport of the baggage once it has been collected from a passenger.

FIG. 3 is a diagram of a preferred embodiment of the system of the invention.

FIG. 4 is a flowchart illustrating the steps in a preferred embodiment of the present invention.

### DETAILED DESCRIPTION

The present invention provides a system and a method for processing cruise ship passengers and their baggage. The below described preferred embodiments illustrate adaptations of these systems and methods. Nonetheless, from the description of these embodiments, other aspects of the invention can be developed and/or practiced based on the description provided below.

In brief overview, the system and method of the invention are used by a passenger who has traveled on a cruise ship and who is traveling from the seaport where the cruise ship has docked to another destination (e.g., residence, hotel) via a commercial flight. In a typical embodiment, before the passenger boards the cruise ship, the passenger has arranged for processing (e.g., providing identification, itinerary information, and/or baggage information to the airline) according to the invention. This is usually done at the time the passenger books the cruise and in some cases is arranged as part of an airfare package. Alternatively, the passenger can arrange for processing subsequent to booking the cruise (e.g., at any time up to the day of final debarkation). Before the day of final debarkation, the number of passengers using the processing system of the invention and the number of pieces of baggage that are to be processed is determined. This is typically done by the airlines that flew the passengers to the cruise ship. This information can also be determined by the cruise ship personnel or can be provided by the passengers themselves. The list of passengers is submitted to an appropriate screening process (e.g., Computer Assisted Passenger Profiling System (CAPPS)). Those passengers designated or selected from the screening process (e.g., as “selectees” by CAPPS) are prevented from using the system of the invention. For those passengers not designated during the screening process and that have baggage to be checked onboard a flight, the entity operating the system of the invention, which is linked to the networks of the airlines, electronically transmits boarding passes and pseudo baggage cards (PBC) for those passengers to the crew of the ship. The PBC is a bar-coded document used to identify the passenger containing passenger-specific information. The PBC can be affixed to the passenger's baggage, handed to the passenger, or attached to the boarding pass or other boarding documents. The PBC does not constitute a valid baggage identification tag that is used by the airlines. In a typical embodiment, the boarding passes and PBCs are distributed to the appropriate passengers by the ship's crew while the passengers are onboard the ship. In other embodiments, particularly those in which the passenger has not pre-arranged for processing, the passenger receives his or her boarding pass after debarking the ship. For example, the passenger may receive his or her boarding pass at the time the passenger hands his or her baggage over to an authorized agent at the arrival terminal of the seaport.

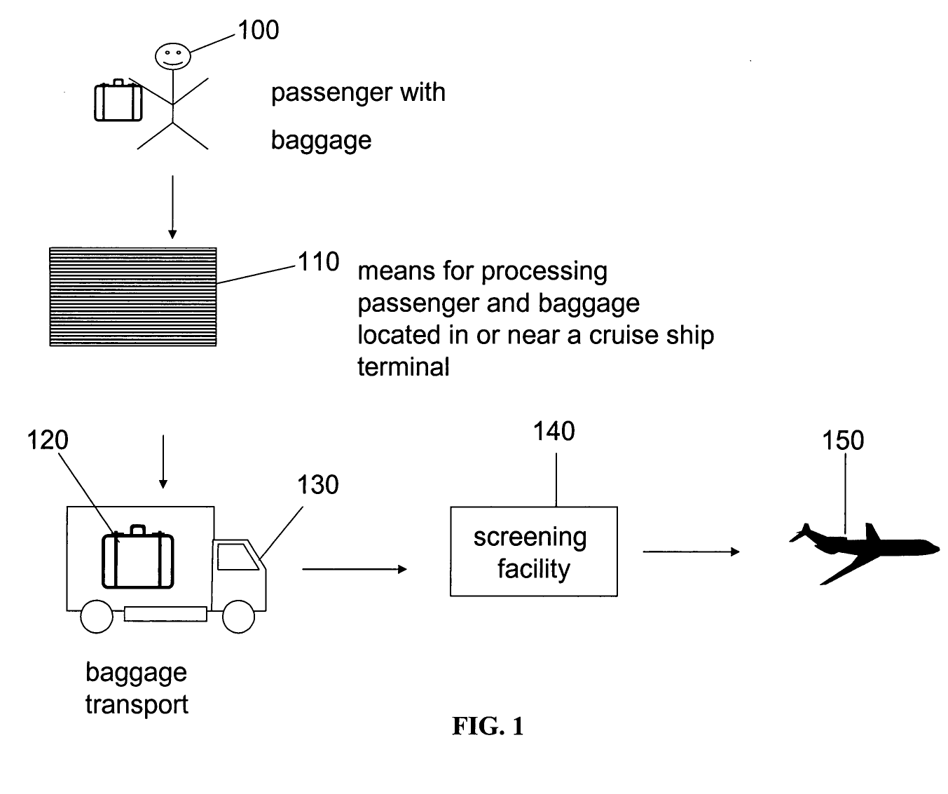

On the night before the final debarkation, the baggage to be processed is collected from the passengers by the ship's crew and stored in a secured area until the baggage is delivered to the cruise ship terminal that receives the arriving passengers and their baggage. Once the passenger has disembarked the ship and arrived in the cruise ship terminal, the passenger takes possession of his or her baggage and can exit the seaport. Where proceeding through customs (e.g., U.S. Customs) is necessary, the passenger takes possession of his or her baggage and transports (i.e., carries, drags, or rolls) it to a customs facility which can be located within the terminal or outside of the terminal. After the passenger has taken possession of his or her baggage (and cleared customs if necessary), referring to FIG. 1, the passenger 100 having baggage 120 who is located at a seaport having at least one cruise ship terminal that is located at least 0.5 km (e.g., 1, 2, 3, 5, 10, 25, 50 or more km) from the airport, and who is scheduled to board a commercial flight to another destination is processed using a means 110 for processing a passenger and baggage. The means 110 includes an authorized agent (e.g., a person authorized by an airline, airport, or governmental authority to provide such service). After clearing customs, the passenger 100 proceeds with his or her baggage 120 to an authorized agent acting on behalf of the entity operating the system of the invention. The authorized agent is located at a designated area located near the terminal where the passengers have arrived. In some cases, the designated area is located near the exit of the customs facility. The designated area is typically marked with appropriate signage so that it is easily recognized and found by the passengers. The passenger 100 presents valid proof of identification (e.g., driver's license, passport) and the PBC(s) to the authorized agent. The authorized agent may additionally ask the passenger 100 security questions. The authorized agent electronically scans the PBC(s) to produce valid baggage identification tags for each piece of baggage 120.

One baggage identification tag is attached to each piece of baggage 120. The baggage identification tag is preferably marked with a barcode or like identification device, the data from the barcode matching an entry in a database within the airline network (e.g., computer system) or baggage processing server described below. The authorized agent preferably has a hand-held or portable identifying device (e.g., barcode scanning device) in communication with the database that is able to read the barcode or like identification device. Using the hand-held or portable identifying device (e.g., barcode scanning device), the authorized agent is able to generate a log of all baggage 120 that is taken into possession by the authorized agent. Alternatively, the authorized agent can generate a log of all baggage by non-electronic means. Each piece of baggage 120 may also be marked with a radio frequency identification (RFID) tag to further facilitate tracking of the piece of baggage 120. In this embodiment, the authorized agent has a hand-held or portable identifying device able to communicate with the RFID. Typically, a baggage claim receipt is issued by the authorized agent to evidence receipt of the passenger's baggage 120. In the event the baggage 120 is misplaced or lost, the passenger's claim receipt can be used to facilitate reclaiming of the baggage 120 or for filing a claim of lost baggage.

In preferred embodiments, an authorized agent confirms that the identity of the passenger matches the identity on the boarding pass. The authorized agent can confirm the identity of the passenger 100 using any suitable means (e.g., driver's license, passport, biometric identification). The authorized agent may additionally screen the passenger 100 with security questions and report the screening results to the airline or appropriate security agency.

After the passenger's identification has been established, the baggage identification tags are attached to the baggage 120 and the authorized agent takes possession of the tagged baggage 120. It is subsequently transported to a screening facility where the baggage 120 is screened. If the baggage 120 clears the screening process, it is transported to a location designated by the appropriate airline (e.g., airplane, airport baggage sorting/handling system).

In some embodiments, passengers who did not arrange to have their baggage processed prior to boarding the cruise ship can arrange to have their baggage processed after they have disembarked. In this embodiment, passengers can use passenger/baggage processing kiosks or portable processing devices. A kiosk of the invention enables the passenger to check-in for a particular flight and to receive a boarding pass. The kiosk can additionally be used by the passenger to book a flight, change a reservation, as well as perform other functions traditionally performed at an airline ticket counter. The passenger/baggage processing kiosk also provides baggage scales and sizers for weighing baggage and determining if the baggage exceeds an established weight limit. The passenger/baggage processing kiosk also provides the passenger access to a passenger and baggage processing computer system that interfaces with the network(s) of one or more airlines. After the passenger enters the appropriate identification information into the kiosk, the kiosk prints one or more baggage identification tags, a baggage claim receipt, and one or more boarding passes. An authorized agent confirms the identity of the passenger, attaches the baggage identification tag(s) to the baggage, and collects the tagged baggage for transport to a screening facility where the baggage is screened.

In a preferred embodiment, the screening facility is located on the airport grounds but away from the passenger terminals. By locating the screening facility away from the passenger terminals, the security of the screening process is enhanced by moving the screening process away from the noise and confusion often present at passenger terminals. The safety of people within the airport is increased by locating the screening facility away from the passenger terminals because, for example, any bomb explosion that occurs at the screening facility would impact people at the airport less than a bomb explosion that occurs in the passenger terminals. For this reason, in preferred embodiments, the screening facility is located at a distance from the airport terminals in the range of about 0.1 to about 2.0 km or more (e.g., 0.08, 0.1, 0.5, 1.0, 1.5, 2.0, 2.2, 10, 50 km).

The screening facility can be partially located on the airfield and partially located on a site that is accessible to the public. The screening facility can also be entirely located on the airfield or on a site that is not accessible to the public. In another embodiment, the screening facility is located at a site that is not on airport grounds. By locating the screening facility off-site from the airport terminals, the high costs associated with airport space can be decreased. In some embodiments, however, it may be desirable to locate the screening facility within or near the passenger terminals.

Once the passenger has handed off the baggage to the authorized agent, the passenger is free to proceed to the airport without the physical constraints imposed by the baggage. Once screened and deemed safe, the baggage is then transported to a location designated by the airline (e.g., appropriate airplane, airport baggage sorting/handling system). Because the passenger has checked-in for the flight and received a boarding pass, the passenger can proceed directly to the departure gate and does not have to wait in what is typically a long line at the airline ticket counter.

Upon taking possession of the baggage and attaching the baggage identification tag(s) to the baggage, the authorized agent transports the baggage from the designated area to a waiting transport vehicle which transports the baggage to the screening facility 140. Alternatively, the authorized agent can wait for a second authorized agent to arrive at the designated area, take possession of the baggage 120, and transport the baggage 120 to a transport vehicle 130. In a preferred embodiment, the authorized agent securely stores the baggage 120 (e.g., in a nearby secured area) while additional passengers' baggage 120 is being processed. This embodiment is preferred because the bulk processing of baggage is more economical and efficient than the processing of individuals. After several passengers 100 have had their baggage 120 processed, the authorized agent can then transport the several passengers' baggage 120 from the designated area or from the secured area to a transport vehicle 130. Alternatively, a second authorized agent can arrive at the designated area or secured area, take possession of the several passengers' baggage 120, and transport the baggage 120 to a transport vehicle 130.

In preferred embodiments, the authorized agent acts on behalf of the entity operating the processing system of the invention. In other embodiments, however, the authorized agent may be an agent acting on behalf of the airline, or an agent acting on behalf of the entity that operates the cruise ship. The authorized agent transports the baggage to the screening facility 140 via any suitable vehicle 130, preferably a van or a truck. In preferred embodiments, the vehicle 130 is equipped with a global positioning system (GPS) tracking device by which an outside party (i.e., law enforcement agency, airline, entity that operates the cruise ship, or entity that operates the baggage processing system of the invention) can track the location of and route taken by the vehicle 130. If the vehicle deviates from its course to the airport, the appropriate outside party can turn-off or disable the vehicle using a remote device in communication with the tracking device.

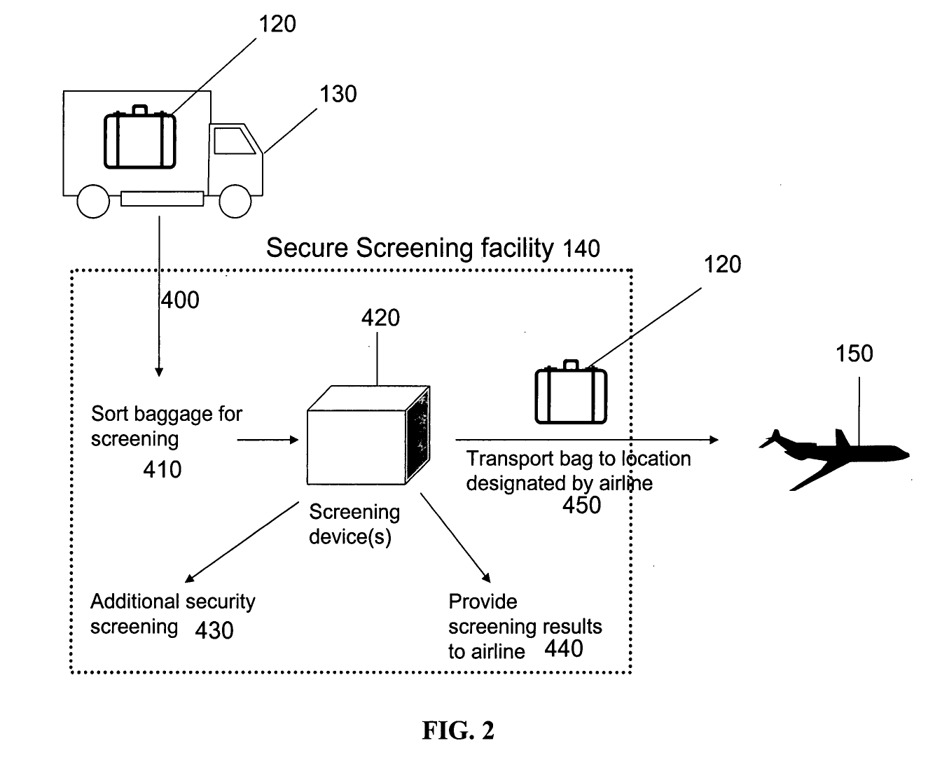

The baggage 120 is transported by an authorized agent to a secure screening facility 140 of the invention (FIG. 2). The screening facility 140 and its procedures comply with all standard requirements and regulations. In the United States, for example, the screening facility 140 and its procedures comply with all airport, state Department of Transportation (DOT), Transportation Security Administration (TSA), and airport carrier security programs and regulations. At the screening facility 140, the incoming baggage 120 can be sorted according to a number of parameters, including airline and flight departure time. For example, baggage 120 can be placed into a priority queue for screening based on flight departure times such that the baggage 120 that has the earliest departure time is screened first. The baggage 120 is screened by any appropriate authorized personnel, including security personnel such as personnel approved and/or employed by the TSA. Once screened, the baggage 120 is securely stored until flight time approaches and then transported to the appropriate airplane 150. The screened baggage 120 can be transported directly from the screening facility 140 to the location designated by the airline (e.g., appropriate airplane 150, airport's baggage sortation/handling system).

As shown in FIG. 2, in step 400, baggage 120 is delivered by at least one authorized agent to the secure screening facility 140. In step 410, received baggage 120 is prioritized and sorted based on the time remaining until the respective flights are scheduled to depart. The baggage 120 may additionally be sorted based on factors such as destination location, bag size, or other factors germane to screening and security. Prior to and after screening, the baggage 120 is held in a secure environment. Within the system of the invention is a means for recording each person who handles a particular piece of baggage 120.

In step 420, the sorted baggage 120 is processed by one or more screening devices or systems. One such device can be an explosive detection system (EDS) machine. The screening facility 140 may have one or several EDS machines. If the screening facility 140 has more than one EDS machine, the baggage 120 can be processed in parallel to increase the efficiency of the screening process. Another appropriate screening device can be an X-ray system for detecting metal objects such as knives and guns. Another screening device useful in the invention is an Electronic Trace Detection System (ETD) which scans for traces of chemicals used to build explosive devices. In step 430, baggage 120 that does not clear screening is flagged for additional security screening. If appropriate, law enforcement agents as well as the owner of the baggage 120 are informed. If the baggage 120 clears the screening process, in step 450, baggage 120 is directed to the appropriate airline for loading onto the appropriate airplane 150. In an alternative embodiment, baggage 120 that clears the screening process can be directed to the airport's baggage sortation/handling system for subsequent transfer to the appropriate airline. In yet another embodiment, baggage that has cleared the screening process can be transported directly to the appropriate airplane. In one variation of the system, the baggage to be screened is placed in an in-line automated system. An in-line automated system allows the baggage to be transported through the screening process described above using a series of conveyors that connect one screening device to another. The use of a conveyor-based system provides for simple reconfiguring or upgrading of the screening facility. If, for example, an additional EDT is to be added to the screening facility, the additional EDT is simply placed amongst existing screening devices and connected to the conveyors. In step 440, screening results are reported to the appropriate airline.

Several benefits are conferred by the passenger and baggage processing system and method of the invention. First, the system and method of the invention eliminate much of the inconvenience and delay associated with airline travel. Not only is the passenger spared from transporting heavy and cumbersome baggage to the airport, but also from waiting in what is typically a long line at the airline ticket counter. Second, the issuance of a boarding pass to the passenger well in advance of the flight and off-site from the passenger terminals decreases congestion at the airport. Third, use of the system and method increases security, as baggage screening is performed in a secure facility less accessible to the public and away from the passenger terminals.

For increasing security, the invention includes a means for tracking the location and integrity of each piece of baggage from the time it is collected from the passenger to the time it is either transferred to the airport sorting/handling system, airline or airplane. The means can include a baggage database storing information on each piece of baggage in communication with a GPS that enables tracking of ground and/or air transportation vehicles transporting the baggage via terrestrial and satellite networks. The baggage database may also be in communication with the computer systems of airlines, departure control systems, and security agencies. Preferably, information such as itinerary changes (e.g., flight delays, cancellations) can be transmitted from airline computer systems to the baggage database. By updating the baggage database with such information, baggage can be routed properly with minimum delay.

As described above, a passenger's baggage is collected from the passenger at a seaport having at least one cruise ship terminal, transported to a screening facility, screened, and loaded onto the passenger's flight. The passenger, therefore, does not transport his or her baggage from the seaport to the airport or wait in line at the ticket counter to check-in and receive a boarding pass. Thus, upon arriving at the airport, the passenger can proceed directly to the departure gate. The passenger and baggage are loaded onto the appropriate airplane and flown to the passenger's destination airport. At the destination airport, the passenger can retrieve his or her baggage from the baggage claim carousel. In other embodiments, the baggage processing system and method of the invention include an additional step of transporting the baggage from the destination airport to the passenger's home, or other final destination. In this embodiment, the passenger is free to leave the airport after landing and proceed home, for example. The passenger is spared from retrieving baggage from the carousel and transporting the baggage home or to another final destination (e.g., hotel, office) because the baggage is delivered directly to a location designated by the passenger.

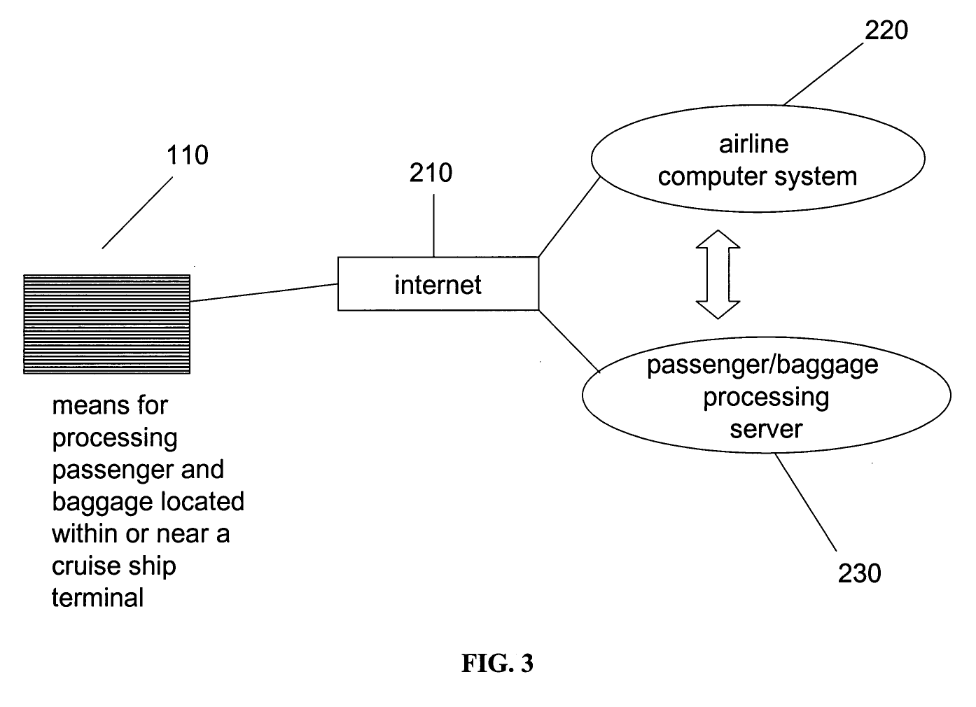

Referring now to FIG. 3, a passenger and his or her baggage is processed by a means 110 for processing a passenger and baggage. The means 110 includes an authorized agent. The authorized agent accesses a passenger and baggage processing computer system 230. In some embodiments, the passenger and baggage processing computer system 230 can be maintained by a server computer having a baggage database. A baggage database of the invention can store baggage identification information in linked relation to a final delivery location (e.g., airport) specified by the user (e.g., passenger). Through the passenger and baggage processing computer system, the authorized agent is linked to the networks (e.g., computer systems 220) of participating airlines. The passenger and baggage processing computer system 230 is linked to the networks 220 of participating airlines via a communications network (e.g., the internet 210). By accessing the passenger and baggage computer system 230, the authorized agent is able to check the passenger in for a reserved flight and generate a boarding pass, a baggage identification tag, and a baggage claim receipt.

In some embodiments, after the passenger's baggage has been tagged and collected by an authorized agent, the passenger is able to check the status of their baggage by accessing the passenger/baggage processing computer system via a conventional computer or an appropriate wireless device. Typically, while the passenger is purchasing airline tickets or purchasing their cruise ship passage, the passenger is presented with the option of arranging for the processing of their baggage according to the invention. It is also possible, however, that the passenger can arrange for processing of their baggage at a time subsequent to purchasing their tickets (e.g., one or more days later, on the day of their flight).

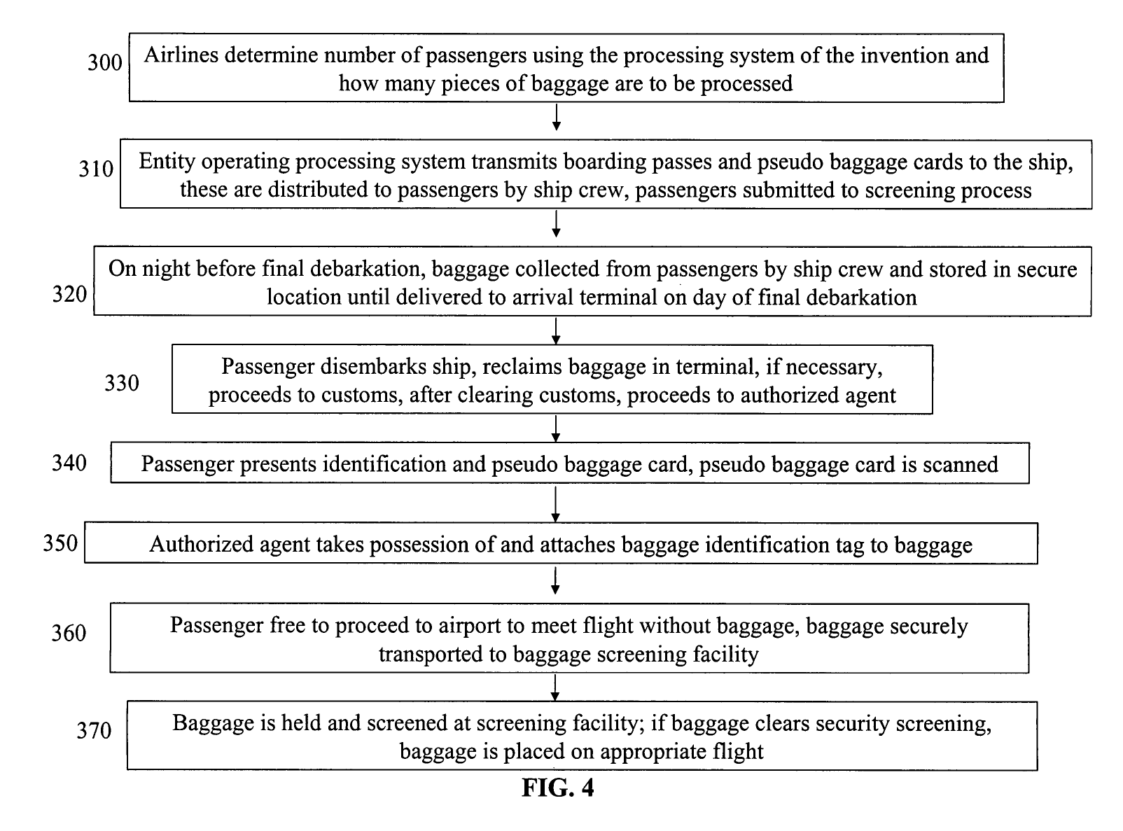

Typical operation of the system and method of the invention is further described in FIG. 4. In step 300, the airlines that flew the passengers to the cruise ship and that will provide flights home for the passengers once they debark the cruise ship determine the number of passengers using the processing system of the invention and how many pieces of baggage are to be processed. This information, however, can be gathered in a number of other ways. Passengers can provide information regarding their baggage via an interactive cable television-based computer on board the ship, an interactive telephone-based system within the passenger cabins, and passenger information cards available at the Purser's Station. Passenger information obtained by these means is based on direct passenger feedback and includes the number of pieces of baggage the passenger intends to check-in. Passenger and baggage information can also be obtained from the official cruse line passenger manifest. In this method, the airlines that provided the passengers with flights to travel to the cruise ship can provide a list of passengers and a projected number of pieces of baggage each passenger is anticipated to check-in. In some embodiments, the travel agency through which the passenger's travel was booked or the airline from whom the passenger has purchased a flight can also provide information to the cruise ship crew regarding number of passengers and pieces of baggage to be processed.

As shown in step 310, the entity operating the system of the invention, which is linked to the airline networks, transmits (e.g., electronically) boarding passes and PBCs to the ship for distribution to respective passengers by the ship's crew. The list of passengers is subjected to an appropriate screening process (e.g., CAPPS) before the PBCs and boarding passes are transmitted, while the PBCs and boarding passes are transmitted, or soon thereafter. In step 320, the night before final debarkation of passengers from the cruise ship, baggage to be processed is collected from the passengers by the ship's crew and stored in a secured location until the baggage is transported to the arrival terminal or to the U.S. Customs and Border Protection (USCBP) warehouse. Step 330 involves passengers disembarking from the ship and proceeding to the arrival terminal or the USCBP warehouse. Also in this step, the passenger reclaims his or her baggage, proceeds through U.S. Customs if necessary, and upon successful clearing of U.S. Customs, proceeds to an authorized agent stationed at a designated area. The authorized agent in typical embodiments acts on behalf of the entity operating the system of the invention.

In step 340, the passenger presents valid identification (e.g., driver's license, passport) and the PBC(s) to the agent and may be asked security questions by the agent. The PBC(s) is electronically scanned by the authorized agent using preferably a hand-held wireless device. After scanning the PBC, the agent generates one baggage identification tag per piece of baggage. As shown in step 350, the agent attaches the baggage identification tags to the baggage and takes possession of the baggage. In step 360, the passenger is then free to proceed to the airport and the baggage is transported to the baggage screening facility. The authorized agent can either transport the baggage from the designated area to a waiting transport vehicle which will transport the baggage to the screening facility, or the authorized agent can wait for a second authorized agent to arrive at the designated area, take possession of the baggage, and transport the baggage to a transport vehicle. In a preferred embodiment, the authorized agent can securely store the baggage (e.g., in a nearby secured area) while additional passengers and their baggage are being processed. After several passengers and their baggage have been processed, the authorized agent can then transport the several passengers' baggage from the designated area or a nearby secured area to a transport vehicle. Alternatively, a second authorized agent can arrive at the designated area or nearby secured area, take possession of the several passengers' baggage, and transport the baggage to a transport vehicle.

In step 370, the baggage is held and screened at the baggage screening facility as described above. After the baggage is processed by one or more screening devices or systems and is deemed safe, the screened baggage is transported to a location designated by the airline (e.g., appropriate airplane, airport baggage sorting/handling system). Preferably, the screened baggage is matched with the passenger upon boarding to ensure that the passenger and his or her baggage are on the same flight. If the authorized agent is delayed in transporting baggage to the screening facility and the baggage is not loaded onto the appropriate flight before the flight departs, or if the flight is missed due to delays in the screening process, arrangements are made for the baggage to be loaded onto another flight. Passenger claims for missing or damaged baggage can be made to and handled by the entity operating the baggage processing system, by an authorized agent, or in some cases, by the appropriate airline or by the entity operating the cruise ship. In the event there are any problems associated with the transport of the baggage (e.g., the baggage is not loaded onto the scheduled flight, the baggage is lost or damaged), attempts are made to notify the passenger as quickly as possible (e.g., by telephone, email).

As noted above in some embodiments, a passenger can monitor the status of his or her baggage transport at any time during the baggage processing by using a computer or wireless communication device (e.g., PDA, cellular telephone, Blackberry™). To obtain the status of one's baggage, the passenger accesses the baggage processing site (e.g., website) and enters appropriate identification information (e.g., social security number, passcode, flight confirmation number, baggage claim receipt information). After the passenger's identification is confirmed (e.g., via entry of any of the identification information above), the status of the baggage of interest is provided to the passenger. The status may be provided by an automated system, by a human being, or by text.

In some embodiments of the invention, entities such as rental car companies, travel agents, and other service providers can be enabled to communicate with the baggage processing server and website to allow such entities to provide baggage-related services to passengers.

While the above specification contains many specifics, these should not be construed as limitations on the scope of the invention, but rather as examples of preferred embodiments thereof. Many other variations are possible. Accordingly, the scope of the invention should be determined not by the embodiments illustrated, but by the appended claims and their legal equivalents.

1. A method for processing at least one cruise ship passenger's baggage for transport on an airline flight departing from a departure airport, the method comprising the steps of:
(a) collecting baggage from the at least one cruise ship passenger at a cruise ship terminal; and
(b) marking the collected baggage with an identifier at the cruise ship terminal, the identifier comprising passenger identifying information and airline flight identifying information.

2. The method of claim 1, wherein the identifier comprises a barcode.

3. The method of claim 1, wherein the identifier comprises an RFID device.

4. The method of claim 1, wherein the identifier is a pseudo baggage card.

5. The method of claim 4, further comprising the step of scanning the pseudo baggage card and generating a baggage identification tag recognizable by an airline.

6. The method of claim 1, further comprising the step of issuing a baggage claim receipt to the passenger.

7. The method of claim 1, wherein the at least one passenger comprises at least 25 passengers.

8. The method of claim 1, wherein the at least one passenger comprises at least 100 passengers.

9. The method of claim 1, wherein the at least one passenger comprises at least 200 passengers.

10. A method for processing at least one cruise ship passenger for travel on an airline flight, the method comprising the step of: issuing a boarding pass for the airline flight to the passenger on a cruise ship or at a cruise ship terminal, the passenger having previously purchased a ticket for the flight.

11. The method of claim 10, further comprising the step of subjecting the at least one passenger to security screening.

12. The method of claim 11, wherein the step of subjecting the at least one passenger to security screening comprises submitting the at least one passenger's name to the Computer Assisted Passenger Profiling System.

13. A method for processing at least one cruise ship passenger and the passenger's baggage for travel on an airline flight departing from a departure airport, the method comprising the steps of:
on a cruise ship or at a cruise ship terminal,
(a) collecting baggage from the at least one cruise ship passenger and marking the collected baggage with an identifier comprising passenger identifying information and airline identifying information; and
(b) issuing a boarding pass to the at least one passenger, the at least one passenger having previously purchased a ticket for the flight.

14. The method of claim 13, wherein a plurality of cruise ship passengers from a single cruise are processed.

15. The method of claim 14, wherein the plurality of cruise ship passengers comprises at least 25 passengers.

16. The method of claim 14, wherein the plurality of cruise ship passengers comprises at least 100 passengers.

17. The method of claim 14, wherein the plurality of cruise ship passengers comprises at least 200 passengers.

18. The method of claim 13, wherein the at least one passenger provided the airline operating the flight with information prior to boarding the cruise ship and is issued the boarding pass while on board the cruise ship.

19. The method of claim 13, wherein at least one of the steps of (a) collecting baggage from the at least one cruise ship passenger and marking the collected baggage with an identifier comprising passenger identifying information and airline identifying information; and (b) issuing a boarding pass to the at least one passenger, the at least one passenger having previously purchased a ticket for the flight, is performed at a kiosk located at the cruise ship terminal.

20. The method of claim 19, wherein the kiosk comprises a scale.

21. The method of claim 20, wherein the kiosk comprises a printer.

22. The method of claim 13, further comprising the step of transporting the collected baggage to the departure airport.

23. The method of claim 13, further comprising the step of transporting the collected baggage to a screening facility located at the departure airport but at least 0.1 km away form any passenger terminal.
